(19) United States
(12) Patent Application Publication
(10) Pub. No.: US 2008/0197790 A1
(43) Pub. Date: Aug. 21, 2008

(54) LIGHTING UTILIZING POWER OVER THE ETHERNET

(76) Inventors: Anthony A. Mangiaracina, Mobile, AL (US); Lyman O. Nielson, Williams, AZ (US)

Correspondence Address: MADSON & AUSTIN, 15 WEST SOUTH TEMPLE, SUITE 900, SALT LAKE CITY, UT, 84101, US

(21) Appl. No.: 12/108,074

(22) Filed: Apr. 23, 2008

Related U.S. Application Data
(63) Continuation-in-part of application No. 11/435,945, filed on May 17, 2006.
Application No. 11/435,945 is a continuation-in-part of application No. 10/733,853, filed on Dec. 11, 2003, now Pat. No. 7,086,747.
Application No. 10/733,853 is a continuation-in-part of application No. 11/455,604, filed on Jun. 19, 2006, now abandoned.
Application No. 11/455,604 is a continuation-in-part of application No. 11/738,909, filed on Apr. 23, 2007.
(60) Provisional application No. 60/913,579, filed on Apr. 24, 2007.
(60) Provisional application No. 60/432,562, filed on Dec. 11, 2002.
(60) Provisional application No. 60/692,117, filed on Jun. 20, 2005.

(51) Int. Cl. H05B 37/00

(52) U.S. Cl. 315/312

(57) ABSTRACT

A lighting system is disclosed in which an Ethernet computer network is used to provide power to one or more light sources that are connected directly to the Ethernet. The light sources may include LEDs, fluorescent lamps, HID lamps, and/or exit signs. The exit signs may incorporate cameras. By providing power to the light sources via the Ethernet, a separate connection to a power supply for the light is not necessary.

### CROSS-REFERENCE TO RELATED APPLICATIONS

This application claims the benefit of U.S. Provisional Patent Application No. 60/913,579 (filed Apr. 24, 2007). This application is also a continuation-in-part of prior U.S. patent application Ser. No. 11/435,945 (filed May 17, 2006), which is a continuation-in-part of U.S. Pat. No. 7,086,747 (filed Dec. 11, 2003), which claims the benefit of U.S. Provisional Patent Application Ser. No. 60/432,562 (filed Dec. 11, 2002). This application is also a continuation-in-part of U.S. patent application Ser. No. 11/455,604 (filed Jun. 19, 2006), which claims the benefit of U.S. Provisional Application No. 60/692,117 (filed Jun. 20, 2005). This application is also a continuation-in-part of U.S. patent application Ser. No. 11/738,909 (filed Apr. 23, 2007). All of these prior patents/patent applications are expressly incorporated herein by reference.

### BACKGROUND OF THE INVENTION

1. The Field of the Invention

The present invention relates to systems for lighting an area. More specifically, the present invention relates to a lighting system that may be used to provide lighting to a specific location, yet also provide emergency lighting, security lighting, low-level night lighting, or other lighting needs.

2. The Relevant Technology

For about one hundred years, electric lights and lighting systems have been routinely used in buildings, offices, and residences. In fact, building safety codes now mandate that lights and lighting systems be part of the building. Thus, any commercial or residential building presently used in the United States should have some type of lights or lighting systems.

One of the most widely used light fixtures in both commercial buildings and residential buildings are the so-called fluorescent lights. Fluorescent lights are generally long-thin cylinders that may be illuminated to provide efficient lighting to a particular area, especially larger rooms or areas. Accordingly, many building owners often use fluorescent lights as a means of saving electricity and/or saving money.

As lighting systems have progressed, other types of lighting systems have also been developed to address specific lighting needs. For example, “emergency” (or “egress”) lighting systems have been developed to increase the safety of buildings. These systems usually include incandescent or halogen lights that are powered by battery backup systems. Specifically, these systems are designed such that these lights will turn on in the event that there is a power outage or other type of emergency. If an emergency or power outage occurs, the emergency lights of these systems illuminate the building and indicate to the building-occupants where the exits are located. Hopefully, by following the indications provided by the emergency lights, the occupants will then be able to efficiently and safely find the appropriate hallways, stairways, etc. that will lead them out of the otherwise dark building. Such emergency lights have the further advantage in that they may also provide light so that rescue personnel (such as firefighters, etc.) can enter and navigate through the building quickly and efficiently.

Most people believe that the inclusion of such emergency lighting systems will increase the overall safety of the building. Thus, most building safety codes mandate that all commercial buildings (including office buildings, theaters, stores, etc.) have emergency lighting systems. Emergency lights, however, are not presently required for most residential buildings.

In addition, many homeowners have also desired additional lighting systems to function as night lighting systems (which are sometimes called “nightlights”). These lights are generally plugged into an electrical outlet and are designed such that during the night (or in other periods of darkness), these lights will provide low-level lighting to an area. Although the amount of light provided by these nightlights is generally small, these nightlights do provide sufficient light so that a person can walk in the area without colliding with the furniture, walls, etc. Parents of small children often purchase such nightlights if their child is “afraid of the dark” or as a way of preventing injury to their child if the child gets up in the night (such as to go the bathroom, to get a drink of water, etc.).

Finally, owners of both commercial and residential buildings have begun using lighting systems as part of the buildings' security system. Generally, these lighting systems (which are sometimes called security lighting systems) are programmed so that multiple lights, in different parts of the house or building, will switch on and off at different times of the day or night. Usually, these security systems will use a timer that is attached to one or more floor lamps such that these lamps will turn on and off at desired times of the day or night. Hopefully, by turning these lights on and off at selected times, a would-be perpetrator will believe that someone is actually present in the building and will be deterred from trying to vandalize/rob the building.

While the above-described lighting systems are generally effective in accomplishing their purpose, such systems are often difficult to install and/or expensive to operate. Moreover, most present systems do not have any way to combine emergency lighting systems with security lighting systems and/or night lighting systems. Further, while fluorescent lights provide “global” lighting for large rooms/areas, many people like additional, location-specific lighting at a person's desk, proximate or over a computer, in a stairwell, over a door, etc. If such location-specific, additional lighting is required, the person must purchase expensive lamps (or other secondary light sources) to provide this additional light source. These secondary light sources often require incandescent light bulbs, and are thus expensive to operate.

Moreover, for many emergency or egress lighting systems, users often forget to check the light bulbs in the emergency lighting system to determine whether such lights have “burned out.” If such lights are burned out, they will not be able to function properly in the event of an emergency. Thus, when the emergency lights are actually needed, they may not be able to function properly.

Accordingly, there is a need in the art for a new type of lighting system that is inexpensive to use and operate. This lighting system will likely include fluorescent lights to take advantage of the cost-savings that are associated with these efficient lighting features. Likewise, there is a need in the art for a lighting system that may be used as an emergency lighting system, a night lighting system, and as a security lighting system. Further, this new lighting system should also provide a person with the ability to provide additional lighting to a specific area, such as proximate a computer, in a stairwell, etc., without requiring the user to purchase lamps or other secondary light sources. There is also a need for a lighting system that will automatically determine whether the emergency lights have “burned out” and will alert the owner of this fact so that the user can take corrective action. Such a device and system is disclosed herein.

### BRIEF SUMMARY OF THE INVENTION

The present embodiments relate to a new type of lighting system that incorporates Power over the Ethernet (PoE) technology. Accordingly, lights in the lighting system will receive the power necessary to illuminate via an Ethernet computer network. In some embodiments, these lights that receive power from the PoE are exit signs or LEDs. The LEDs and/or exit signs powered with the PoE, may also be attached to a battery or other type of “backup” power system so that power is supplied to each fixture/light device to provide light when general power to the building is lost.

The Ethernet will include one or more computers, as is known in the art. In general, the Ethernet will include a server that is attached to a PoE switch device that serves to provide the power through the Ethernet cables to the lights.

It should be recognized readily that using PoE and the present embodiments may provide distinct advantages over other lighting systems. For example, PoE may be used to supply voltage to an office or work area directional lighting source. The lighting source will be located/installed in a ceiling tile or under a work area cabinet to supply a directed and low glare light source. The light may also be positioned proximate a computer so that a person can receive additional light, as desired, in working at his or her computer. The light source may be comprised of LEDs and be uniquely designed to supply a patterned light foot print for a desired area. Thus, no separate power is required for these LEDs.

Lighting system using PoE provide an easy way to implement a security lighting system, a safety lighting system, and an energy-efficient lighting system. For example, those of skill in the art will appreciate that an “Ethernet switch” server/computer may be programmed to control the lights in the system. In some embodiments, this switch may be a simple switch. In other embodiments, this Ethernet switch may be a computer or a server. In other words, the computer may control which lights are allowed to turn on/off at specified times. By having the Ethernet switch control the illumination of the lights, the Ethernet switch can turn on specific lights at night, thereby creating a night-lighting system. The Ethernet switch also can vary which lights are turned on at specified times, thereby creating a “security” lighting system. Of course, embodiments may be constructed in which the user can program/instruct the Ethernet switch regarding turning the lights on or off, thereby giving the user control of the lighting in the building. In fact, embodiments may be made in which the present “lighting system” may be any type of lighting system, including for example, task/work lighting systems, egress lighting systems, emergency lighting systems, decorative lighting systems, 24-hour mandated lighting systems, etc.

The present embodiments also provide for a lighting system that is energy-efficient. Energy conservation is realized by supplying power, via the Ethernet, to LEDs at specific locations for lighting, such as workstations, where fluorescent lights and incandescent lights could be switched off and LED lights switched on.

Similarly, 24-hour mandated lighting and other timed lighting can easily be implemented using lights that receive power via PoE. By having the computer turn the lights on or off as desired. The computer also may be able to control and monitor which lights are on, to determine which persons in the building are wasting energy or where lighting is unnecessary.

Further, the control and monitoring capability using PoE will allow maximum control to manage power draw to avoid surcharges for peak power draw. Local power companies often issue surcharges (or other fees) to persons who use excess power during peak hours, in order to encourage such persons to reduce their power consumption during these hours of the day. By having the system turn off specified lights at peak times, these surcharges may be avoided. Further, the control functions of the computer can be programmed so that the system uses LED lights (rather than fluorescent lights) whenever possible. LEDs are often cheaper to use and will minimize energy consumption, and thus, the use of LEDs, whenever possible, is generally desired.

Controlling the lights via the Ethernet switch may also allow building security to be notified if lights are active in an unauthorized timeframe and/or unauthorized location in a building.

Using the Ethernet power for lighting provides the ability to monitor and control lighting from a computer/server or Ethernet switch system for an entire facility. An example would be, if a building maintenance group was responsible for a 35-story building, they could monitor which lights are operational and which lights have failed, and they could control and timeout certain lights based on need. Being able to recognize which exits signs are not functional will facilitate their quick repair or replacement, which would improve safety and reliable performance.

PoE (Power over the Ethernet) could also be used to monitor emergency lights, which would allow the maintenance group to be notified when an emergency light was not operational. One serious problem, which exists with current “emergency lighting,” is that emergency lights are not often used and they are not easily monitored or tracked. It's an area that is often neglected, which means when the emergency lights are actually needed, they may not be available.

### BRIEF DESCRIPTION OF THE SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawing(s). Understanding that these drawing(s) depict only typical embodiments of the invention and are not therefore to be considered to be limiting of its scope, the invention will be described and explained with additional specificity and detail through the use of the accompanying drawing(s) in which:

FIG. 1 is a schematic view of an exemplary embodiment of a lighting system according to the present embodiments.

### DETAILED DESCRIPTION OF THE INVENTION

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the present invention, is not intended to limit the scope of the invention, as claimed, but is merely representative of presently preferred embodiments of the invention.

The word “exemplary” is used exclusively herein to mean “serving as an example, instance, or illustration.” Any embodiment described herein as “exemplary” is not necessarily to be construed as preferred or advantageous over other embodiments. The word “connected,” when referring to components, does not necessarily mean that these components are adjacent each other or are directly connected to each other via wiring. Rather, when two components are “connected,” they are capable of communicating with each other, regardless of whether there are intervening components added to the system.

Before discussing the present embodiments, a brief summary of Power over Ethernet (or “PoE”) technology is provided. The present lighting systems incorporate PoE technology to control, monitor, and to power the lighting system. PoE technology is a system to transmit electrical power, along with data, to remote devices over standard twisted-pair cable in an Ethernet network. This technology is useful for powering IP telephones, wireless LAN access points, webcams, Ethernet hubs, embedded computers, and other appliances where it would be inconvenient or infeasible to supply power separately. The technology is somewhat comparable to POTS (plain old telephone service) telephones, which also receive power and data (although analog) through the same cable. It works with an unmodified Ethernet cabling infrastructure.

There are several general terms used to describe this feature. The terms Power over Ethernet (PoE), Power over LAN (PoL), Power on LAN (PoL), and Inline Power are synonymous. Any and all of these terms are used to describe the powering of attached devices via Ethernet ports.

Technology related to PoE is defined in the standards set forth by The Institute of Electrical and Electronics Engineers, Inc. (“IEEE”). Particularly, IEEE has put forth a document entitled IEEE 802.3-2005 (which is commonly referred to as “IEEE 802.3af”) which sets forth standards for PoE technology. IEEE 802.3-2005 is expressly incorporated herein by reference. It is generally preferable to use IEEE standard technology (or IEEE standards) when using PoE and PoE technology. However, other types of PoE technologies/techniques, including ad hoc techniques may also be used, provided these techniques are capable of powering devices attached to Ethernet ports.

For purposes of clarity, some of the guidelines and standards set forth in IEEE 802.3-2005 are described herein. However, for a complete description of PoE technology, the reader should consult IEEE 802.3-2005.

Clause 33 of IEEE 802.3-2005 provides some standard techniques and guidelines for PoE. This standard states that 48 volts DC may be transmitted over two out of four available pairs on a Cat. 3/Cat. 5 cable with a maximum current of 400 milliamperes. A “phantom” technique may also be used so that the powered pairs may also carry data. This permits its use not only with 10BASE-T and 100BASE-TX, which use only two of the four pairs in the cable, but also with 1000BASE-T (Gigabit Ethernet), which uses all four pairs for data transmission. Data and power transmission is possible because all versions of Ethernet over twisted pair cable specify differential data transmission over each pair with transformer coupling; the DC supply and load connections can be made to the transformer center-taps at each end. Each pair thus operates in “common mode” as one side of the DC supply, so two pairs are required to complete the circuit. The polarity of the DC supply is unspecified; the powered device must operate with either polarity or pair 45+78 or 12+36 with the use of a bridge rectifier. It should be noted that the present application is not limited to the use of DC PoE. Other embodiments may be designed in which AC power is supplied via PoE or PoE technology. Other embodiments may be designed in which AC high frequency power is supplied. In some DC PoE applications, PoE may be limited to 80 w and about 100 meter cable runs. However, in other embodiments that use AC PoE, the cable runs may be much longer. Accordingly, any type of power means may be used in the present application with PoE technology. For example, PoE may be supplied as DC, AC, AC AC—symmetrical AC, square wave, repetitive, non-repective, small pulse, etc.

The IEEE 802.3-2005 standard describes two types of devices: Power Sourcing Equipment (PSE) and Powered Devices (PD). Power Sourcing Equipment provides power to the Powered Devices.

As explained by the IEEE standard, two modes for PoE are available, namely “mode A” and “mode B.” In mode A, pins 1-2 (pair #2 in TIA-568B wiring) form one side of the 48 volt DC supply, and pins 3-6 (pair #3 in TIA-568B) provide the 48 V return. These are the same two pairs used for data transmission in 10 Base-T and 100BASE-TX, allowing the provision of both power and data over only two pairs in such networks.

In mode B, pins 4-5 (pair #1 in both TIA-568A and TIA-568B) form one side of the DC supply and pins 7-8 (pair 4 in TIA-568A and TIA-568B) provide the return; these are the “spare” pairs in 10BASE-T and 100BASE-TX. Mode B, therefore, requires a 4-pair cable.

The power sourcing equipment (PSE) decides whether power mode A or B is to be used, not the powered device (PD). The PSE can implement mode A or B or both (but must not supply power in both modes at the same time). A PD indicates that it is standards-compliant by placing a 25 kiloohm resistor between the powered pairs. If the PSE detects a resistance that is too high or too low (including a short circuit), no power is applied. This protects devices that do not support IEEE 802.3af. An optional “power class” feature allows the PD to indicate its power requirements by changing the sense resistance at higher voltages. To stay powered, the PD must continuously use 5-10 mA for at least 60 ms with no less than 400 ms since last use or else it will be un-powered by the PSE.

There are two types of PSEs specified by IEEE802.3-2005: endspans and midspans. Endspans are Ethernet switches that include the Power over Ethernet transmission circuitry. Endspans are commonly called PoE switches. Midspans are power injectors that stand between a regular Ethernet switch and the powered device, injecting power without affecting the data. Endspans are normally used when the switch has to be replaced for other reasons (such as moving from 10/100 to 1 gigabit or adding security protocols), and then it is convenient to add also the PoE capability. Midspans are used when there is no desire to replace and configure a new Ethernet switch, and only PoE needs to be added to the network.

One of the unique elements of the present lighting system is that it will incorporate PoE technology. More specifically, PoE technology is used to control, monitor, and to power these low-voltage lighting systems. The lighting system may be a low-voltage lighting system that includes one or more light emitting diodes (LEDs). Thus, in embodiments of the present systems, PoE may be used to supply power to the lights or LEDs in the lighting system. PoE technology may also be used to power an exit sign or other light sources in the system. The lights and/or exit signs powered by the PoE, may also be attached to a battery or other type of “backup” power system so that power (or “backup power”) is supplied to each fixture/light device to provide light when general power to the building is lost.

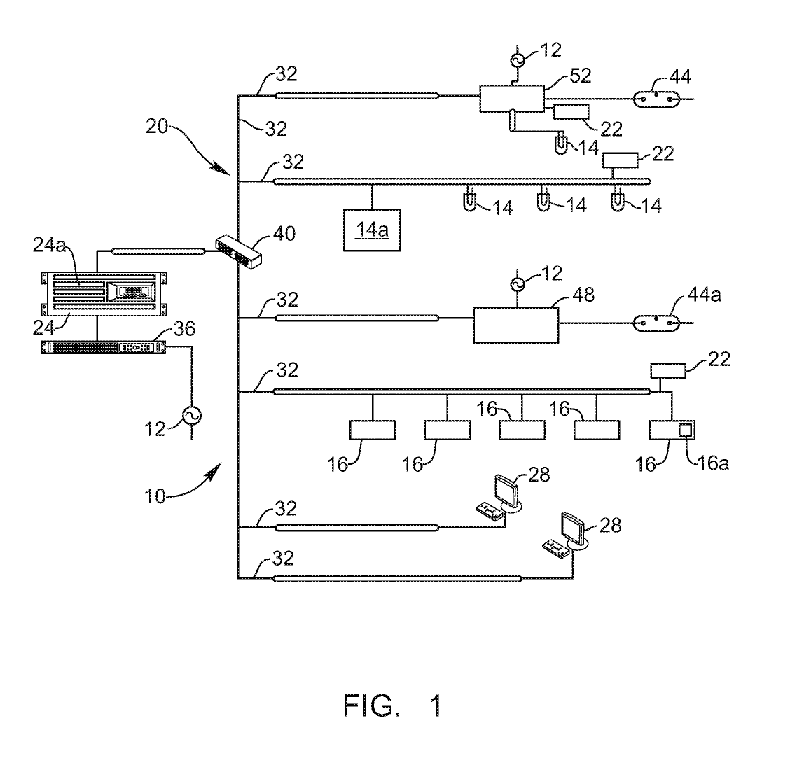

Referring now to FIG. 1, an embodiment of a lighting system 10 that may be used to light a building. As will be explained herein, this system may be used to provide light to rooms or areas of a building. In other embodiments, the system 10 may also be used to provide lighting to the entirety of the building. As will be explained in greater detail herein, the present system may also provide security lighting, night lighting, and/or emergency lighting, depending upon the features/elements that are used to construct the system 10.

The system 10 may be attached to an AC voltage source 12. This AC voltage source 12 is generally the AC voltage source that provides power to the building. This AC voltage source 12 is provided by the municipal or local power company. Those of skill in the art will appreciate how to wire the system 10 such that it receives AC voltage from the voltage source 12.

The system 10 will also include one or more light sources 14. In some embodiments, these lights 14 are preferably LEDs 14. Other types of light sources may also be used. The LEDs 14 may be distributed throughout the building in desired locations including at a person's desk/workstation, proximate a person's computer, in stairways, in hallways, proximate the building's exits, in the ceiling, in the floor, along the walls, or at other locations where additional lighting is necessary. (These locations for lights are described, in detail, in the patent/patent applications referenced above). The fact that LEDs 14 are used means that such lights are low-voltage and can be operated very inexpensively. At the same time, such LEDs 14 may provide ample/adequate light as desired.

The system 10 may also include one or more exit signs 16. These exit signs 16 may be designed such that they are constantly illuminated. Other embodiments may be designed in which the exit signs 16 will illuminate when the building is dark, when power is lost to the building, during an emergency situation, etc. The exit signs 16 are positioned proximate the exits of the building so that the occupants can properly use and access these exits when they need to leave the premises. In other embodiments, the exit signs 16 will provide a pathway that the user can follow to exit the premises. As part of many commercial buildings, the use of such exit signs 16 are mandated by building codes, regulations, etc.

The lighting system 10 may include an Ethernet computer network 20 (which is sometimes referred to herein as an Ethernet). Those skilled in the art will know how to implement/construct an Ethernet. The Ethernet 20 will include at least one computer 24. As used herein, the term “computer” includes all types of electronic computing devices that are capable of processing information and include, but are not limited to, controllers, microcontrollers, hand-held computers, personal computers, desktop computers, mobile computer devices (including PDAs, cell phones, etc.), servers, mainframes, supercomputers, artificial intelligence systems, and/or combinations thereof and simply other possible Ethernet switches. In the embodiment shown in FIG. 1, the computer 24 is a server 24a.

The server 24a may be located anywhere in the building, as desired. However, in some embodiments, the server 24a will be located in a closet, electrical room, storage room, etc. so that it is a “out of the way.” The computers 28 may be located anywhere throughout the building, such as a workstation, a person's desk, etc. Of course, the server 24 may be located remote from the building (such as in another building). This remote server may be beneficial as it may not be damaged by an emergency occurring at the building.

One or more additional computers 28 may be added to the Ethernet 20, thereby forming a computer network. Again, those skilled in the art will appreciate how to construct the Ethernet 20 to include these computers 28 and/or to allow communications/interactions between the nodes on the Ethernet (including both computers 28 and the computer 24). The computers 24, 28 may be connected as part of the Ethernet 20 via one or more cables 32. These cables 32 may be standard Ethernet cables. In some embodiments, these cables 32 will be the standard Ethernet Category-5 (“Cat-5”) cables. In other embodiments, other types of standard cables, including Category 3 or Category 6 cables may also be used. Generically, these standard cables are referred to as “Cat-n” cables. Other types of standard and/or non-standard Ethernet cables may also be used. In other embodiments, the cables 32 will be CAT-n Cables that are capable of up to 80 watts per channel (or other wattages per channel, as desired). Other types of wireless communication protocols or wireless communication methods may also be used in forming all or a portion of the Ethernet 20.

It should be noted that, in some embodiments, the Ethernet 20 will be created using the standards and protocols set forth for Ethernets by the IEEE. That way, the Ethernet will be standardized and could be applied to a wide variety of applications/platforms. In creating this “standard” Ethernet, standard types of wires, cables, etc. will be used. Of course, other types of non-standard equipment, wires, etc. may be used in particular embodiments. In some embodiments, PoE will be used as a power source for several useful functions. The low power data signaling, as part of an 802.x Ethernet standards, will not be used active in the following applications, but rather the power supplied by a given PSE (Power Supply Equipment), such as standard network PoE switch devices.

In some embodiments, the computer 24 may be attached to a power supply 36. This power supply may be a uniform power supply or UPS. As is known in the art, the UPS 36 is a battery or other similar device that receives power from the AC source 12. However, in the event that the AC voltage source 12 no longer provides power (such as when the power is “out”, or when there is an emergency, etc.), the UPS 36 will provide power/voltage to the Ethernet 20 and/or the computer 24. The length of the time that the UPS 36 will provide power to the Ethernet 20 will depend on a variety of factors including the size of the UPS 36, the number of nodes on the Ethernet 20, the number of nodes on the Ethernet 20 that are being supplied power by the UPS 36, etc. In some embodiments, the UPS 36 provides power to illuminate the LEDs 14 or other lights in the system and/or the exit signs 16 in the event of a power outage. However, in other embodiments, one or more additional batteries 22 may also be configured to supply power to the LEDs 14 and/or the exit signs 16 during a power outage, thereby providing light to the building occupants so that they can safely exit the building, etc.

As explained herein, the Ethernet 20 may be used to provide the requisite power necessary to illuminate/power the LEDs 14 and/or the exit signs 16. This is accomplished via PoE technology discussed above. Accordingly, the LEDs 14 and/or the exit signs 16 may be attached to the Ethernet 20 and/or the cables 32 and will draw their power from the Ethernet 20. In this manner, a separate connection to the AC source 12 of the building may not be required.

As noted above, PoE technology requires a PD (powered device) and a PSE (power sourcing equipment) in order to provide power to the device via the Ethernet. In the embodiment of FIG. 1, the powered devices are the exit signs 16/LEDs 14, as these are the devices receiving power over the Ethernet 20. The Ethernet 20 may also include a PoE switch device 40 that serves as the PSE. The PoE switch device 40 operates as described above, and can transmit power to the PDs in either mode A or mode B. The (PSE) decides whether power mode A or B is to be used, not the powered device (PD).

In the embodiment of FIG. 1, the switch device 40 is an “endspan” that includes Ethernet transmission circuitry as specified by IEEE802.3-2005. Endspans are normally used when the switch device 40 has to be replaced for other reasons (such as moving from 10/100 to 1 gigabit or adding security protocols), and then it is convenient to add also the PoE capability. In other embodiments, the PSE may be a midspan. As noted above, such midspans are power injectors that stand between a regular Ethernet switch and the powered device, injecting power without affecting the data. Midspans are used when there is no desire to replace and configure a new Ethernet switch, and only PoE needs to be added to the network. Those of skill in the art will understand where and how they can implement the switch device 40 to provide power over the Ethernet 20.

As shown in FIG. 1, the system 10 may also include one or more fluorescent lights 44. In fact, in some embodiments, fluorescent lights 44 may be used as part of the system 10. As known in the art, fluorescent lights 44 are often used to provide light to areas of a building. Such fluorescent lights may be less expensive to operate than are traditional incandescent light bulbs. The number of fluorescent lights 44 will depend upon a variety of factors including the area to be illuminated, the desired level of light in the building, etc. Any number of fluorescent lights 44 may be used. Of course, incandescent lights can also be used, but fluorescent lights 44 may be more efficient.

These fluorescent lights 44 may be used in conjunction with a standard ballast 48. These type of ballasts 48 are known in the art and may be required to produce the constant voltage that is necessary to operate a fluorescent lights 44. The ballast 48 may also be attached to the AC voltage source 12 of the building. This AC voltage source 12 provides the power necessary to illuminate the fluorescent lights 44. In other embodiments, the ballast 48 may be attached to a battery that will be capable of illuminating the LEDs 14 in the event that the AC voltage source 12 no longer produces power. In other embodiments, a separate battery is not required as the UPS 36 will provide power sufficient to illuminate the LED 14. Such power is supplied to the LED 14 via the Ethernet 20 using PoE technology.

In other embodiments, the fluorescent lights 44 may be attached to a multifunctional ballast 52. This multifunctional ballast is described in the patent/patent applications listed above, including (for example) U.S. Pat. No. 7,086,747 and U.S. patent application Ser. No. 11/435,945. The multifunctional ballast 52 receives voltage from the AC voltage source 12. The multifunctional ballast 52 may also be used in conjunction with an LED 14. As explained in the patent/patent applications described above, this multifunctional ballast 52 is designed such that the fluorescent lights 44 will be illuminated if high levels of lighting/illumination are required. However, if low-level lighting would adequately serve the lighting needs, such as for emergency lighting, after-hours lighting, security lighting, etc., the LED 14 will be illuminated. It should also be noted that some of the lights 14 may be compact fluorescent lights 44a (which are sometimes called “compact fluorescent lamps”). (These compact fluorescent lights may be used with or without the ballast, as desired). Compact fluorescent lights are known in the art and may be smaller or more compact than regular fluorescent lights. Those skilled in the art will appreciate how such compact, fluorescent lights may be used. It should also be noted, however, that any type of light may be used with the present system as the light source, including fluorescent or non-fluorescent lights. For example, in other embodiments, the light source 14 includes a HID lamp 14a (e.g., a “high intensity discharge” lamp). Those skilled in the art will appreciate that HID lamps are known in the industry and such a skilled artisan would appreciate how this type of lighting device may be used.

In some embodiments, the multifunctional ballast 52 may be attached to a battery 22 that will be capable of illuminating the LEDs 14 in the event that the AC voltage source 12 no longer produces power. The battery 22 provides DC power to the light sources if the AC voltage 12 is not providing power. In other embodiments, a separate battery is not required as the UPS 36 will provide power sufficient to illuminate the LED 14. Such power is supplied to the LED 14 via the Ethernet 20 using PoE technology.

It should readily be recognized that using PoE and the present embodiments may provide distinct advantages over other lighting systems. For example, PoE (and more specifically PSE) may be used to supply voltage to an office or work area directional lighting source. The lighting source will be located/installed in a ceiling tile or under a work area cabinet to supply a directed and low glare light source. The light may also be positioned proximate a computer so that a person can receive additional light, as desired, in working at his or her computer. The light source may be comprised of LEDs and be uniquely designed to supply a patterned light foot print for a desired area. Thus, no separate power is required for these LEDs.

Second, the lighting system using PoE provides an easy way to implement a security lighting system, a safety lighting system, and an energy-efficient lighting system. For example, those of skill in the art will appreciate that the computer 24/server 24a may be programmed to control the lights in the system 10. In other words, the computer 24 may control which lights are allowed to turn on/off at specified times. In other embodiments, the computer 24 will control the power being transferred to a particular light/LED 14 via PoE at specified hours during the day. Clearly, if no power reaches the light source, the light will not be able to illuminate. By having the computer control the illumination of the lights, the computer can turn on specific lights at night, thereby creating a night-lighting system. The computer can also vary which lights are turned on at specified times, thereby creating a “security” lighting system. Of course, embodiments may be constructed in which the user can program/instruct the computer regarding turning the lights on or off, thereby giving the user control of the lighting in the building.

By utilizing PoE for power and control of the lights in the system 10, safety lighting, security lighting and energy conservation in hallways, stairwells, and other locations may be accomplished. Energy conservation is realized by using high intensity, low-voltage power PSE (Power Supply Equipment) to supply power to specific locations for lighting, such as workstations, where fluorescent lights and incandescent lights could be switched off and LED lights switched on. The LED lights could then be lit with high intensity low-voltage power through the Ethernet. Other examples would be lighting in hallways and stairwells, using specialized fixtures which are designed with multifunctional ballasts, which would allow a system to switch between fluorescent or LED lights.

A computer 24 (such as the server 24a), through the Ethernet, could then monitor and/or control, when light sources (or LEDS 14 on or off as desired) are to function and would allow control for maximum energy conservation. Thus, the lights can be turned off to conserve energy when such lighting is not required (such as afterhours, etc.). Similarly, 24-hour mandated lighting and other timed lighting can easily be implemented using lights that receive power via PoE. By having the computer 24 turn the lights on or off as desired. The computer 24 may also be able to control and monitor which lights are on, to determine which persons in the building are wasting energy or where lighting is unnecessary. Moreover, as shown in FIG. 1, one or more of exit signs may include a camera 16a such as a CCD camera or other type of camera. The camera 16a may be able to monitor the area proximate the camera or the exit sign and provide visual information to the computer 24. The computer 24 may also be capable of turning the camera 16a on and off, controlling the camera, changing the camera angle, zooming in or out, etc.

Further, the control and monitoring capability using PoE will allow maximum control to manage power draw to avoid surcharges for peak power draw. Local power companies often issue surcharges (or other fees) to persons who use excess power during peak hours, in order to encourage such persons to reduce their power consumption during these hours of the day. By having the system 10 turn off specified lights at peak times, these surcharges may be avoided. Further, the control functions of the computer 24 can be programmed so that the system 10 uses LED lights (rather than fluorescent lights) whenever possible. LEDs are often cheaper to use and will minimize energy consumption, and thus, the use of LEDs, whenever possible, is generally desired.

Finally, controlling the lights via the computer 24 may also allow building security to be notified if lights are active in an unauthorized timeframe and/or unauthorized location in a building. Some buildings have areas that are “offlimits” in that they store sensitive information or materials (such as vaults, file rooms, etc.). Other areas of the building may be “public” at certain hours of the day, but may be “offlimits” afterhours. Obviously, if the lights are turned “on” in these offlimit areas, it may be an indication that an unauthorized person has accessed areas of the building. Accordingly, if the computer monitors when the lights are turned on/off, the system 10 may be able to notify building security that an unauthorized person is in the building.

The use of PoE to power exit signs may also provide additional advantages. For example, a PSE may be used to supply voltage to building/facility exit signs. The exit signs will take advantage of low power Light Emitting Diodes (LED), which require much less power (voltage) to illuminate. In this case a standard, Cat3/5/6 network cable, will be run from the PoE switch/device to each exit sign location supplying the power necessary to light the LED's and therefore illuminate the sign. Additionally, the power supplied by the PoE system will be used to charge backup battery packs, which will supply power to the LED lights when or if power supplied by the PoE device is interrupted.

Using the Ethernet power for lighting provides the ability to monitor and control lighting from a computer for an entire facility. An example would be, if a building maintenance group was responsible for a 35-story building, they could monitor which lights are operational and which lights have failed, and they could control and timeout certain lights based on need. Additionally, being able to recognize which exits signs are not functional will facilitate their quick repair or replacement, which would improve safety and reliable performance.

PoE (Power over the Ethernet) could also be used to monitor emergency lights, which would allow the maintenance group to be notified when an emergency light was not operational. One serious problem, which exists with current “emergency lighting,” is that emergency lights are not often used and they are not easily monitored or tracked. It's an area that is often neglected, which means when the emergency lights are actually needed, they may not be available.

With the Ethernet system, a maintenance group of a 35-story building (example above) would be able to accomplish all control and monitoring functions from a single server, alerts generated to notify which systems are not functional, and all this would be done without having to visit each floor and each fixture. Of course, the benefit is reduced labor costs, more effective maintenance, early recognition of failed systems, and quick repair of failed systems. Reliability of the lighting system in an emergency is a major safety factor. Improving reliability is a major safety benefit.

With use of Ethernet technology, a single computer can control and monitor every light, including fluorescent lights with multifunctional ballasts, in a building using various Ethernet protocols such as SNMP (Simple Network Management Protocol) to communicate with the ballast and other applicable devices. This allows maximum control for conservation of energy and power, resulting in the benefit of financial savings. This control could also be utilized for security issues, such as timed lighting, lighting specific areas at specific times, monitoring lights as to when they are typically used, detecting when their use is atypical, and even supporting camera surveillance by computer.

Using high intensity power through the Ethernet will allow easier and less costly installations. This may allow for reduced voltage drop and longer electrical runs. Cat-n cable could be used, in place of, high-voltage (120/277 volt) copper wire, which must be installed in conduit for both commercial and industrial installations. An example, demonstrating the ease of installation of PoE (Power over the Ethernet) systems, would be use of Cat-n cable, dropping it down a wall, running it through a wall, and then using a RJ-45 connector, connecting it to a workstation light, an emergency light, or an exit sign. This can be done without conduit since PoE is a low-voltage power source. Then each light, including the ‘exit signs’, could be easily installed, resulting in less time and materials.

In comparing the present embodiment with currently known embodiments, used to install workstation lighting and exit signs, the installation process would be greatly simplified and installation costs would be substantially reduced. As part of the present embodiment, part or all lights, including exits signs, will also be supported with low-voltage battery backup, so that when power is lost, they can continue to function as emergency lights. When either high-voltage lighting (like fluorescent lights) or low-voltage lighting (like LED lights) is desired, then it may be desired to use a multifunctional ballast 52, as described above. In using this multifunctional ballast 52, it may still be necessary to install copper wire and conduit for high-voltage power (120/277 volt). The exception may be retrofit installations. In the case of retrofit, the copper wire and conduit may already be in place and it would only be a matter of running Cat-n cable, installing the multifunctional ballasts, installing remote LED or fluorescent lamp light fixtures, and new PoE exit signs.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. A lighting system comprising:
a Ethernet computer network;
one or more light sources connected to the Ethernet; and;
a power supply connected to the Ethernet, wherein power is supplied to the light source via the Ethernet.

2. A lighting system as in claim 1 further comprising a computer and a power supply device that forms a part of the Ethernet, wherein the computer is connected to the power supply device.

3. A lighting system as in claim 2 wherein the computer is capable of turning each of the light sources on or off.

4. A lighting system as in claim 2 wherein the computer monitors the light sources to determine whether the light sources are operational.

5. A lighting system as in claim 1 wherein the power supply is an AC power source.

6. A lighting system as in claim 1 wherein the light source comprises an LED.

7. A lighting system as in claim 1 further comprising one or more exit signs that are connected to the Ethernet, wherein power to illuminate the exit signs is supplied by the Ethernet.

8. A lighting system as in claim 7 wherein the exit sign further comprises a CCD camera.

9. A lighting system as in claim 1 further comprising a battery that is capable of supplying power to at least one of the light sources.

10. A lighting system as in claim 9 wherein the power supply is an AC power source, wherein the system is designed such that if the AC power source does not produce power, DC power is supplied from the battery to at least one of the light sources.

11. A lighting system as in claim 1 further comprising one or more additional computers that may communicate via the Ethernet.

12. A lighting system as in claim 1 wherein the light sources are connected to the Ethernet via a Cat-n cable.

13. A lighting system as in claim 1 wherein the lighting system may be any type of lighting system including, for example, task/work lighting, egress lighting, emergency lighting, decorative lighting, 24-hour mandated lighting, etc.

14. A lighting system as in claim 1 wherein the light source comprises fluorescent lamps.

15. A lighting system as in claim 1 wherein the light source comprises compact fluorescent lamps.

16. A lighting system as in claim 1 wherein the light source comprises an HID lamp.

17. A lighting system comprising:
a Ethernet computer network, the network including a server;
one or more light sources connected to the Ethernet, the light sources being connected to a multi-functional ballast; and;
a power supply connected to the Ethernet, wherein power is supplied to the light source via the Ethernet.
